(19) United States
(12) Patent Application Publication
(10) Pub. No.: US 2012/0184347 A1
(43) Pub. Date: Jul. 19, 2012

(54) GAMING SYSTEM AND A METHOD OF GAMING

(75) Inventor: Blake Freele, Glebe (AU)

(73) Assignee: ARISTOCRAT TECHNOLOGIES AUSTRALIA PTY LIMITED, North Ryde (AU)

(21) Appl. No.: 13/355,180

(22) Filed: Jan. 20, 2012

Related U.S. Application Data
(63) Continuation of application No. 12/492,204, filed on Jun. 26, 2009, now abandoned.

(30) Foreign Application Priority Data
Jun. 27, 2008 (AU) 2008903290

(51) Int. Cl. A63F 13/00; A63F 9/24

(52) U.S. Cl. 463/20; 463/35; 463/31

(57) ABSTRACT

Certain examples relate to a gaming system and a method of gaming for playing a reel-type game. A game controller of the gaming system is arranged to select a plurality of symbols from a set of symbols and to control a display to display a plurality of the selected symbols in rows and columns. A player interface enables a player to select game features, including selecting one or more or all of the reels against which to bet credit. Each time a feature is selected, a sound generator generates a distinctive sound associated with selection of that feature. A “special” game feature may also be selected. In an embodiment, the special game feature is selection of all the reels against which to bet credit. When the special feature is deselected, by a player selecting another game feature, an alert sound is generated to alert the player to the fact that they have deselected the special game feature.

### CROSS-REFERENCE TO RELATED APPLICATIONS

This patent arises from and claims priority to as a continuation of U.S. patent application Ser. No. 12/492,204, filed Jun. 26, 2009, entitled “A GAMING SYSTEM AND A METHOD OF GAMING,” which claims the benefit of priority to Australian Provisional Patent Application No. 2008903290, filed on Jun. 27, 2008, entitled “A GAMING SYSTEM AND A METHOD OF GAMING”, each of which is herein incorporated by reference in its entirety.

### THE INVENTION

The present invention relates to a gaming system and a method of gaming

### BACKGROUND OF THE INVENTION

It is known to provide a gaming system which comprises a game controller arranged to control the random display of several symbols from a pre-determined set of symbols and to determine a game outcome such as a game win, based on the displayed symbols. Such gaming systems may commonly be implemented as a stepper machine provided with reels, with each reel carrying several symbols of the set, or a video machine wherein selected symbols are displayed on virtual reels on a graphical display device. Win outcomes can occur based on symbols appearing on one or more horizontal lines, diagonal lines, or in any other pre-determined way.

In known gaming systems of this type, the player can choose to place a wager for one or more win outcomes. For example, a player may choose whether or not to wager on one or more “win lines”. A win line is a pre-determined line through an arrangement of symbol positions in the column and row array provided by the reels. In some gaming systems, it is also or alternatively possible to wager on one or more reels. In known gaming systems, many different win combinations are available.

In some cases, particularly where a number of game features are available for player selection, a player may operate the gaming system in error to make a selection of a gaming feature that they did not intend to make. This can result in dissatisfaction and complaint. For example, if a player intended to bet on many win lines to give them a better chance of winning a jackpot prize, and by mistake they only select a single win line, then they will be upset when the jackpot combination comes up on one of the win lines that, in error, they failed to select. Such errors are of fairly common occurrence in gaming systems of this type.

### SUMMARY OF THE INVENTION

In accordance with a first aspect, the present invention provides a gaming system, including a game controller arranged to control play of a game, a player interface operable by a player to affect a plurality of game features, and a sound generator arranged to generate a plurality of distinct sounds, each distinct sound being associated with operation of a respective one of the plurality of game features, the sound generator being arranged to generate an alert sound when operation of one of the game features also affects operation of another game feature.

In an embodiment, the game feature is a special game feature. The game features may include a plurality of standard features and one or more special features. For example, a special game feature may be a jackpot feature, or, in a reel game, a feature which means all the lines and/or reels in the game are bet on by the player. In an embodiment, operation of the interface to deselect the special game feature, due to, for example, operation of the interface to select one of the other game features, may result in the sound generator generating the alert sound.

In an embodiment, the operation of the game feature is one or more of enabling and disabling of a game feature.

In an embodiment, the sound generator is arranged to generate the alert sound when the game feature is disabled in response to enabling of another game feature.

In an embodiment, the player interface includes a plurality of controls, each control being arranged to affect operation of a respective one of the plurality of game features. In an embodiment, each one of the plurality of distinct sounds is associated with operation of each respective control. In an embodiment, the alert sound is generated when operation of one of the controls also affects operation of another game feature not associated with the control. In an embodiment, the alert sound is generated in place of the distinct sound usually associated with that control.

In an embodiment, the gaming system further includes a display arranged to display a representation of play of the game. In an embodiment, the game controller is arranged to control the display to provide an indication when a game feature is affected. In an embodiment, a different indication is provided for operation of each game feature. In an embodiment, the indication is provided by illumination of the interface. In an embodiment, the indication is provided by illuminating one or more controls provided by the interface. In an embodiment, the indication is provided by different patterns of illumination.

In an embodiment, the gaming system includes a display and the game controller is arranged to select a plurality of symbols from a set of symbols for play of the game. The game controller is arranged to control the display to display a plurality of the selected symbols in one or both of rows and columns. The game controller is arranged to determine game outcomes based on combinations of the selected symbols in the one or both rows or columns. In an embodiment, the game features controlled by the game interface are selection of one or more of the rows or columns where the combinations are to appear. In an embodiment, the player, via the player interface may select one of the rows and columns, two of the rows and columns, or more. In an embodiment, the player may bet credit on their selection. In an embodiment, one of the game features is selection of all of the rows and columns. Deselection of this game feature may give rise to the alert sound.

In accordance with a second aspect, the present invention provides a method of gaming, including the steps of operating a game having a plurality of game features, generating distinct sounds, each distinct sound being associated with operation of a respective one of the plurality of game features, and generating an alert sound when operation of one of the game features also affects operation of another game feature.

In accordance with a third aspect, the present invention includes a computer program, including instructions for controlling a computer to implement a gaming system in accordance with the first aspect of the invention.

In accordance with a fourth aspect, the present invention provides a computer readable medium providing a computer program in accordance with the third aspect of the invention.

In accordance with a fifth aspect, the present invention provides a data signal including a computer program in accordance with the third aspect of the invention.

### BRIEF DESCRIPTION OF THE DRAWINGS

Features and advantages of the present invention will become apparent from the following description of embodiments thereof, by way of example only, with reference to the accompanying drawings, in which;

FIG. 1 is a schematic block diagram of core components of a gaming system in accordance with an embodiment of the present invention;

FIG. 2 is a diagrammatic representation of a gaming system in accordance with an embodiment of the present invention with the gaming system implemented in the form of a stand alone gaming machine;

FIG. 3 is a schematic block diagram of operative components of the gaming machine shown in FIG. 2;

FIG. 4 is a schematic block diagram of components of a memory of the gaming machine shown in FIG. 2;

FIG. 5 is a schematic diagram of a gaming system in accordance with an alternative embodiment of the present invention with the gaming system implemented over a network;

FIG. 6 is a schematic diagram of functional components of a gaming system in accordance with an embodiment of the present invention;

FIGS. 7 through 9 are representations of example displays generated by a gaming system in accordance with an embodiment of the present invention, and

FIG. 10 is a flow diagram illustrating operation of a gaming system in accordance with an embodiment of the present invention.

Features, further aspects, and advantages of the present invention will become apparent from the following description of embodiments thereof, by way of example only, with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### DETAILED DESCRIPTION OF EMBODIMENTS

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in at least one embodiment, at least one of the elements is hereby expressly defined to include a tangible medium such as a memory, DVD, CD, etc. storing the software and/or firmware.

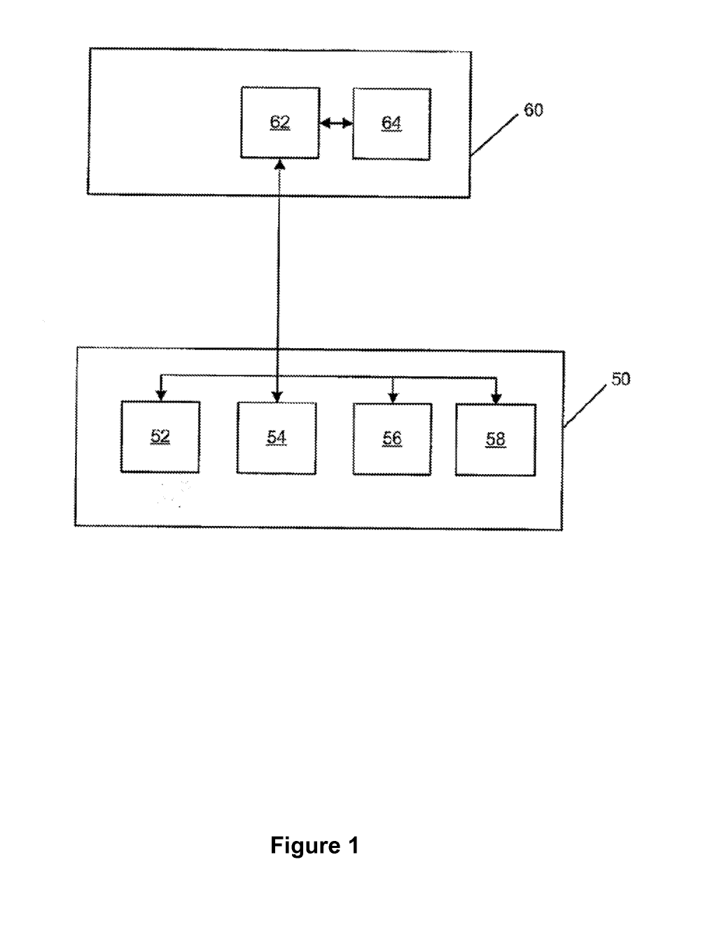

Referring to the drawings, there are shown example embodiments of gaming systems which are arranged to implement a game in which a plurality of symbols are selected from a set of symbols in order to determine a game outcome. A player interface (see for example reference numeral 50 in FIG. 1) is operable by a player to affect a plurality of game features. In one example, the game features may be an arrangement of lines or reels which the player may bet credit against. In this embodiment, depending on which lines and/or reels the player bets credit against, i.e. which game features are affected by the player, a particular distinct sound is generated by a sound generator. In circumstances where operation of one of the game features also affects another game feature, the distinct sound usually associated with operation of that particular feature is not generated, and, instead, an alert sound is generated by the sound generator. This alerts the player to the fact that another of the game features is being affected, operation of which may or may not be desired by the player.

The gaming system can take a number of different forms. In a first form, a stand alone gaming machine is provided wherein all or most components to implement the game are present in a player operable gaming machine.

In a second form, a distributed architecture is provided wherein some of the components to implement the game are present in a player operable gaming machine and some of the components to implement the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

Irrespective of the form, the gaming system includes several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54, a game play mechanism 56 that enables a player to input game play instructions (e.g. to place bets), and sound generating equipment 58 including one or more speakers and amplifiers.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server. The game controller 60 is also arranged to produce audio signals for reproduction as sound by the sound generating equipment 58.

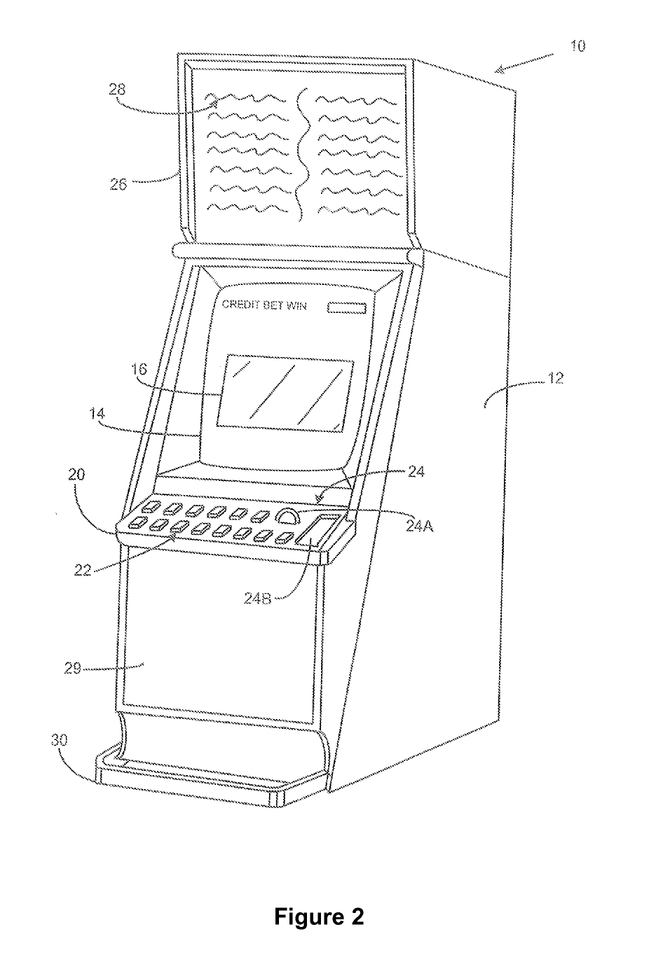

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type. The gaming machine 10 also houses sound generating equipment including speakers (not shown).

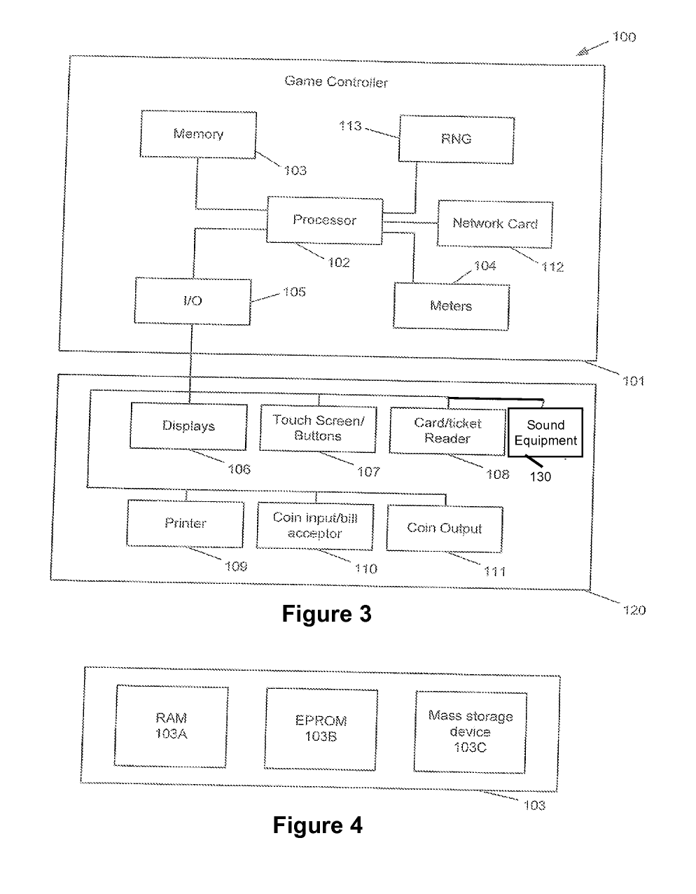

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 include one or more displays 106, a touch screen and/or buttons 107, a card and/or ticket reader 108, a printer 109, a bill acceptor and/or coin input mechanism 110, a coin output mechanism 111 and sound generating equipment 130, such as speakers and amplifiers. Additional hardware may be included as part of the gaming machine 100, or hardware may be omitted based on the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111, 130 to be provided remotely from the game controller 101.

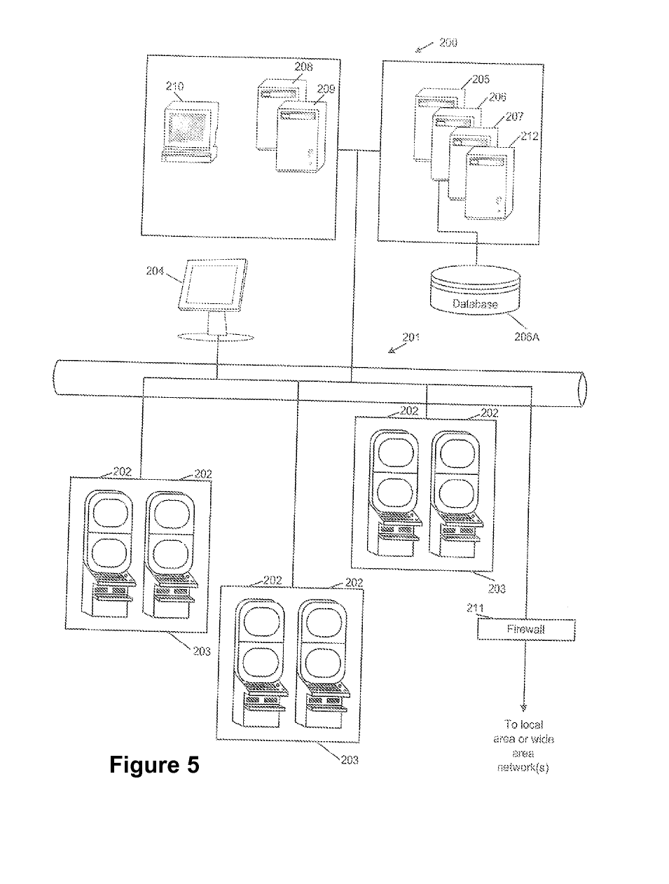

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements, rules, guidelines, and/or preferences for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games based on the terminals.

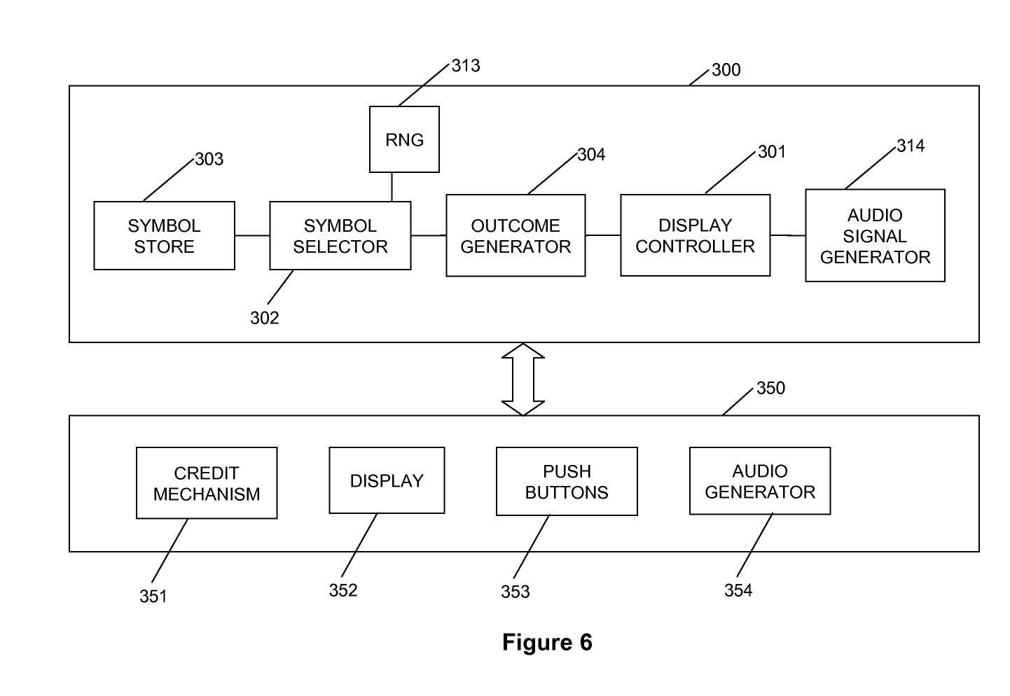

Referring to FIG. 6, the functionality of embodiments of the present invention may be implemented by a game controller having the functional components illustrated. In this embodiment, the functional components are implemented utilising game controller components such as a processor and memory (such as in FIG. 3, or game controller 60 in FIG. 1, or the game server 205 in FIG. 5), and associated programming. Other implementations are envisaged. For example the functional blocks of FIG. 6 may be implemented in hardware as separate units, or a combination of hardware and software as separate units. Any practical implementation of these functional units may be employed.

In this embodiment, the game controller 300 is arranged to control the gaming system to play a game which includes selection of a plurality of symbols from a set of symbols. The game is implemented as a “reel” game. The game controller 300 includes a display controller 301 which is arranged to control the display (reference numerals 54, 14, 106, 204 of previous figures) to emulate a representation of reels bearing symbols. Alternatively, the display may include a stepper motor and physical reels bearing the symbols.

The game controller 300 includes a symbol selector 302 which is arranged to select a plurality of symbols from a set of symbols available in a symbol store 303. A random number generator (RNG) 313 is used to implement random selection of the symbols by the symbol selector 302, by providing random numbers. The RNG 313 may be a software or hardware RNG implementation. It may be a standard True Random Number Generator (TRNG) or a standard Pseudo Random Number Generator (PRNG), or any other implementation. An outcome generator 304 is arranged to determine an outcome of the game. In this embodiment, the outcome of the game depends on the selected symbols and may include a win outcome, loss outcome, trigger outcome, a feature outcome or other outcome. Outcomes may be determined on the basis of symbols appearing in one or more horizontal lines, diagonal lines, or any other pre-determined combinations. An audio signal generator 314 is arranged to generate audio signals for reproduction as sound.

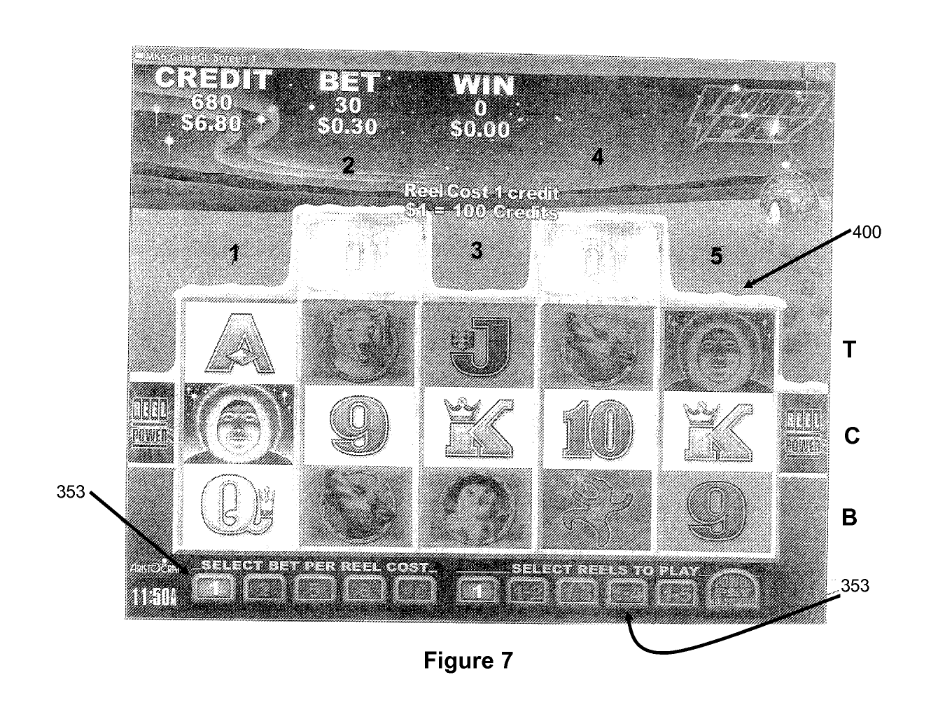

FIG. 7 shows a representation of a gaming machine display 400 which, in the example shown, has five reels (numbered “1” to “5”). The display 400 shows three reel positions high when the reels have stopped/the symbols have been selected. The reel positions are designated Bottom (“B”), Centre (“C”) and Top (“T”). This is a typical reel-type display for a gaming machine. It will be appreciated that in other embodiments the number of reel positions may be more or less than in display 400. Also the number of reels may be more or less than in the display 400.

The reels may be virtual reels, generated as a video display from the selected symbols, actual mechanical reels carrying the symbols and driven by a stepper motor, or any other reel arrangement or emulation. In the case of actual physical reels, the game controller drives a stepper motor to randomly select the symbols appearing in the display 400.

The game outcome is determined by the outcome generator 304 based on combinations of symbols selected and appearing in the display 400. The symbols may be any symbols. As will be appreciated, many different types of symbols are used in gaming systems. A set of symbols may include standard symbols and function symbols. For example, standard symbols may resemble fruit such as apples, pears and bananas with a win outcome being determined when a predetermined number of the same fruit appear on a display in the same line, scattered, and so on. The function associated with a function symbol may be a “wild” function wherein display of the function symbol is treated during consideration of the game outcome as any of the standard symbols. Other functions may include scatter functions, multiplier functions, repeat win functions, jackpot functions and feature commencement functions.

In the example shown in FIG. 7, the symbols are representations of cards. In this example, a winning hand appearing on the C line may cause the outcome generator to determine that a Win has occurred and that an appropriate prize may be awarded. For example, five of a kind (e.g. 5 jacks “J”. 5 tens “10” etc) on the C line may result in a win.

In addition to the card symbols there are other symbols, which may be function symbols and also “wild card” symbols.

The diagram shown in FIG. 7 is one way of representing the symbols only. It will be appreciated that in other embodiments of the invention symbols may be represented in different ways, using any type of fancy artwork, or in any appropriate manner.

Referring again to FIG. 6, the game controller 300 is arranged to communicate with a player interface 350. The player interface includes a credit mechanism 351 (such as credit mechanism 52 referred to in FIG. 1; 24A and 24B of FIG. 2; 108, 110 and 111 of FIG. 3). It also includes a display 352 (54 of FIG. 1, 14 of FIG. 2, 106 of FIG. 3). Player operable push buttons 353 are also provided (56 of FIG. 1, 22 of FIG. 2, 107 of FIG. 3). Push buttons 253 are also shown in FIGS. 7 to 9. An audio generator 354 is also provided which is arranged to generate sounds based on audio signals from the audio signal generator 314. Audio signal generator 314 and audio generator 354 in this embodiment together form a sound generator. In other embodiments, a sound generator may be implemented in other ways. In this embodiment, the audio generator 354 includes sound generating equipment such as an amplifier and at least one speaker (58 of FIG. 1, 130 of FIG. 3).

Operation of an embodiment of the present invention will now be described with reference to FIGS. 7 through 9, which show example displays generated by the gaming system of FIG. 6 playing a game known as Reel Power™ (by Aristocrat Leisure Industries PTY Limited).

The display controller 301 controls the display 352 to generate a representation of five video reels 400. In Reel Power™, a player is able to obtain a win entitlement by selecting a number of reels to play. The selection of a reel means that each symbol of the reel can be substituted for a symbol at one or more designated display positions. In other words, all symbol positions of a selected reel can be used to form symbol combinations with designated, displayed symbol positions of other reels.

A player selects the reels to play by operation of controls, in this embodiment being in the form of push buttons 353.

Referring to FIG. 7, of the 10 push buttons 353 at the bottom of the display five of them are labelled “SELECT REELS TO PLAY”. FIG. 7 shows that push button “1” has been actuated. The push button “1” is illuminated to indicate that it has been operated. Actuation of push button “1” affects a game feature (in this example embodiment, selecting reel 1 to play). In the display 400, the symbols appearing in reel 1 are all illuminated. Also, all of the symbols on the centre line C are illuminated. This indicates that combinations can be made between all of the symbols in reel 1 and all of the symbols on the centre line C, for determining game outcomes.

When push button “1” is actuated by the player, this is detected by the game controller 300. The audio signal generator 314 generates an audio signal reproduced as a sound by audio generator 354. A distinct sound “A” is associated with actuation of push button “1”. Buttons “1-2”, “1-3”, “1-4” and “1-5” are all associated with their respective distinct sounds (e.g. sound “B”, sound “C”, sound “D” and sound “E”, respectively).

The more reels that are selected by the player, the more chances the player has of obtaining a desired game outcome.

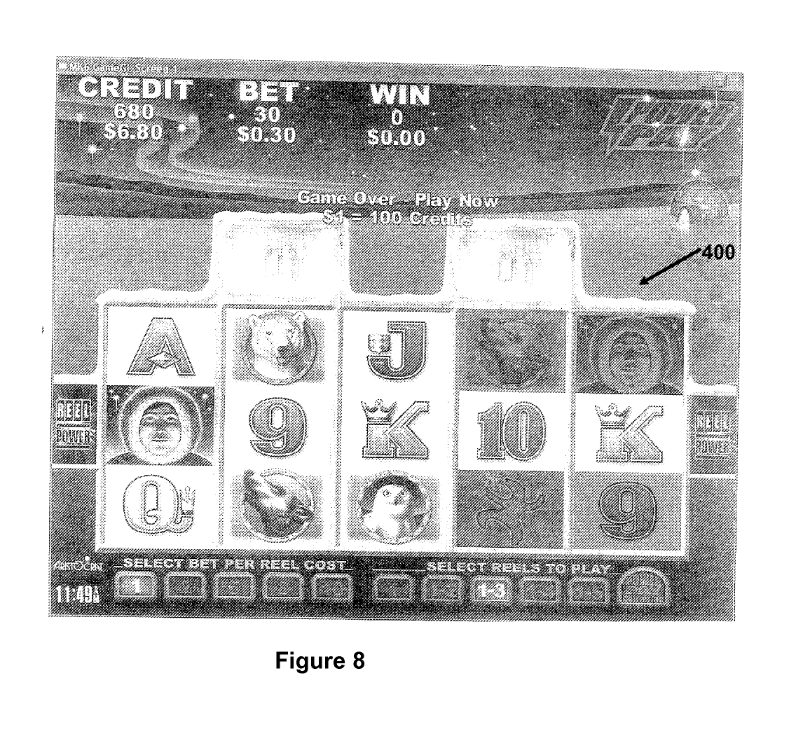

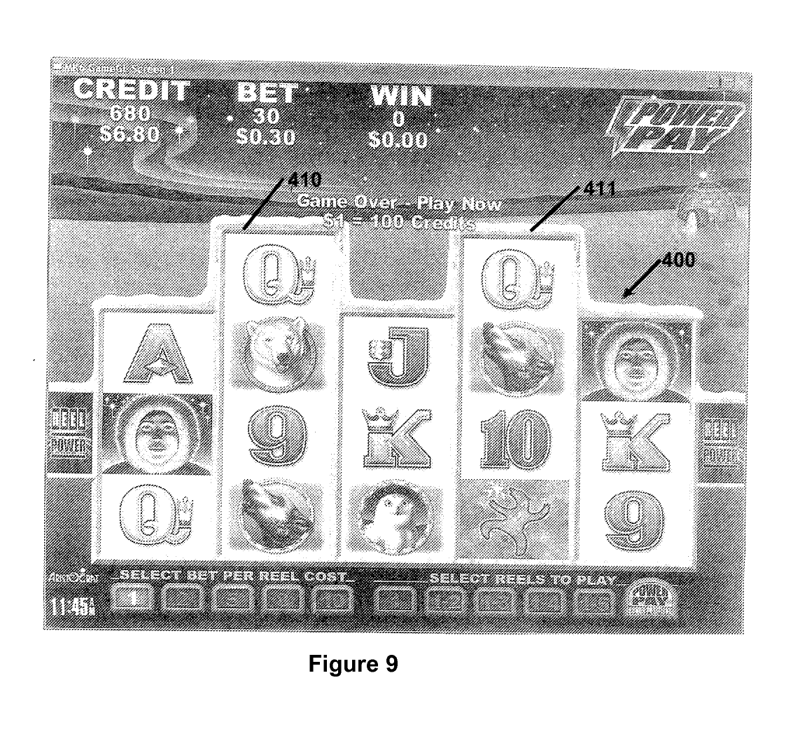

Referring to FIG. 8, for example, the player has selected “1-3” button and three reels have therefore been selected (these three reels are illuminated in the reel display 400). Any of the symbols appearing on the selected three reels may be combined with any of the symbols appearing on the center line C, giving a plurality of chances for a winning symbol combination.

As well as the “SELECT REELS TO PLAY” buttons, there are also 5 “SELECT BET PER REEL COST” buttons. These enable a player to place a credit bet against each reel they select, in this case being either 1,2,5,8 or 20 credits corresponding with the labels on the “SELECT BET PER REEL COST” push buttons.

In this embodiment, the audio signal generator 314 also generates an audio signal reproduced by the audio signal generator as a distinctive sound for each of the SELECT BET PER REEL COST buttons.

In a conventional gaming system of this type, each of the buttons is associated with its own distinct sound which does not vary. This can lead to problems.

Referring to FIG. 9, the “POWER PAY” button has been actuated by the player. The Audio Signal Generator 314 and Audio Generator 354 generate another distinct sound “F” to indicate that “POWER PAY” has been actuated. In this embodiment, all of the reel positions in the display 400 are now illuminated which means that a maximum number of combinations of symbols is available for play. Further, two extra symbol positions 410 and 411 have been revealed, to give the opportunity for yet further symbol combinations. The display controller 301 controls the display so that the further two symbol positions 410 and 411, which in other displays are obscured by a graphic (see FIGS. 7 and 8) are now revealed.

In this embodiment the POWER PAY game feature allows for the maximum number of combinations of symbols.

In a conventional gaming system of this type, if a player then actuates one of the SELECT REELS TO PLAY buttons “1-3”, then the sound C associated with that button is played. When the “1-3” button is actuated when POWER PAY has been selected POWER PAY will be deselected and the sound C for 1-3 will be played. This can lead to problems in that the player may not necessarily be aware that the POWER PAY feature has been deselected.

Such situations arise often in gaming venues and lead to many complaints.

In this embodiment of the invention, this problem is addressed in the following way.

Where the game feature of POWER PAY is selected, and the player subsequently selects another one of the SELECT REELS TO PLAY buttons, such that POWER PAY is deselected, instead of the usual sound associated with the particular SELECT REELS TO PLAY button, the audio signal generator 314 and audio generator 354 generate another sound, sound “G”, which operates as an alert sound. This alerts the player to the fact that POWER PAY has been deselected by their selection of another SELECT REELS TO PLAY button.

The alert sound G gives a psychological reinforcer to the player, making it more likely that the player will become aware that the POWER PAY feature has been deselected. Providing an audio reinforcer has been shown to be more likely to ensure that a player is aware of the operation being audio reinforced. In addition, in this embodiment, a visual reinforcer is given by the display 400, in particular the positions 410 and 411 being obscured again (by an ice like graphic). Visual and audio reinforcement of the change, in this case a deselection of the special feature, is a powerful reminder to the player.

In this embodiment, the alert sound is generated when the special feature of POWER PAY is deselected as a consequence of another one of the SELECT REELS TO PLAY buttons being depressed. Alert sounds maybe generated when other of the game features are deselected as a consequence of selecting another game feature.

For example, when a client is determining how much credit they bet on a reel, they may select the “10 Bet Per Reel Cost” button. If subsequently they select another of the SELECT BET PER REEL COST buttons, such that the 10 button is deselected, then the sound generated by actuation of the other SELECT BET PER REEL COST button may not be the usual sound associated with that button, but may be an alert sound.

In this embodiment, when a “special feature” is deselected in consequence of another game feature being selected, an alert sound is played. In the above embodiment, the special feature is POWER PAY. In other embodiments, with other games, the special feature may be any special feature. It could be deselection of a special bet for a jackpot. For example, in a game of video poker, it may be possible to bet credits on a particular hand coming up to win a jackpot. This may be considered to be a “special bet”. If a player deselects the special bet, as a consequence of selecting another bet, then an alert sound would be generated. This warns the player that they have deselected the special bet for the jackpot, which they may have done accidentally.

The invention is not limited to applications in which special game features are deselected. It may be applied where any game feature is deselected as a consequence of selection of another game feature. The sounds alerts a person that that a game feature has been deselected. It provides a relatively powerful reinforcer to the player so that they are aware what is going on in the game.

In at least embodiments, the invention has the advantage of reducing the number of player errors and therefore reducing the number of complaints.

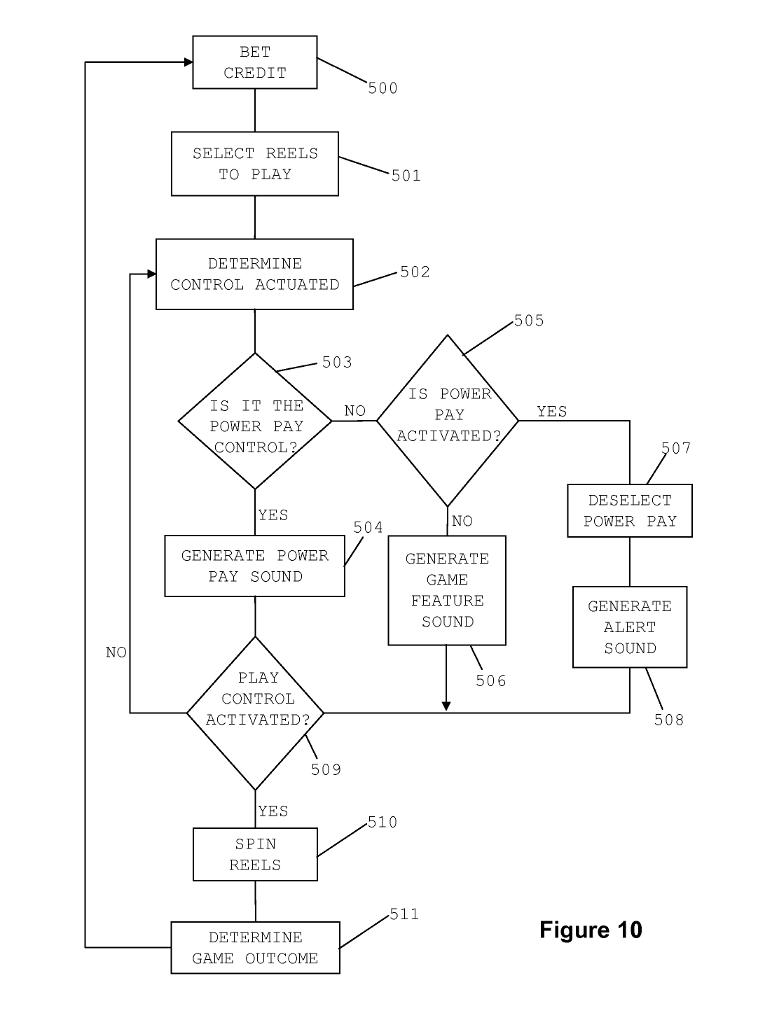

The game playing process in accordance with the embodiment of the present invention implemented as a Reel Power game will now be summarised with reference to FIG. 10.

At step 500, a player bets an amount of credit on the REEL POWER™ game. At step 501, the player actuates the controls to select the REELS TO PLAY. At step 502 a determination is made as to which control is actuated. A determination is made as to whether it is the POWER PAY control (step 503). If YES, then at step 504 the POWER PAY sound is generated. If NO, then at step 505 a determination is made as to whether or not the POWER PAY feature is activated. If it is not, then at step 506, the game feature sound associated with the control actuated is generated. If at step 505, it is found that POWER PAY is activated, then at step 507, the POWER PAY game feature is deselected.

At step 508, the alert sound is generated by the Audio Signal Generator 314 and Audio Generator 354. The alert sound is generated instead of the sound that is associated with the control which has actually been actuated. This alerts the player that the POWER PAY feature has been deselected.

At step 509, determination is made as to whether or not a PLAY GAME control has been actuated. Note that this control is not shown in FIGS. 7 through 9, but may be implemented by a button or touch screen button on a control panel of the gaming system.

If YES, then at step 510 the reels of the gaming machine are spun to display the symbols determined by the symbol selector 302. At step 511 the game outcome is determined by outcome generator 304. Any prize will subsequently be paid to the player.

If, at step 509, the determination is made that it is not the PLAY GAME control which has been actuated, then the process returns to step 502 to determine which control has been actuated.

In the above embodiment, the display emulates a plurality of reels. In an alternative embodiment, symbol selection may be implemented as actual reels driven by a stepper motor. In another embodiment, the display may not emulate reels but merely show the selected symbols in a non-reel format e.g. presenting them as emulated playing cards, or other graphical representations in a series of rows and columns.

In the above embodiment, the invention is applied to a game where a plurality of symbols are selected from a set of symbols, and combinations of the selected symbols are formed in one or more of rows and columns and game outcomes are determined from the symbol combinations. The invention is not limited to application with only these types of games. The invention may be applied in other games. For example, the invention may be applied in Bingo.

In Bingo, a series of numbers are selected by a player. They are usually arranged in an array, including the plurality of lines. The player selects whether they want to play lines of numbers or the entire array of numbers, for example. Further numbers are then selected and matched against the players “array” of numbers. When a player has received matching numbers that complete a line, he may have a win, or when he receives matching numbers that complete an entire array, he has a win. In this embodiment of the invention, the player may select one or more lines or the array. If the full array of numbers is selected, and then the player decides to select a line, this may result in de-selection of the array and generation of the alert sound.

A similar application of this invention may be made in relation to Keno.

The invention may also be applied in other games.

It will be appreciated that the method of the embodiment may be embodied in programme code and the gaming system may be implemented by appropriate programming of a computing device. The programme code may be supplied in a number of ways, for example, on a computer readable medium, such as a disk or a memory (for example, that could replace part of memory 103) or as a data signal (for example, by downloading it from a server).

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be understood that the invention disclosed and defined in this specification extends to all alternative combinations of two or more of the individual features mentioned or evident from the text or drawings. All of these different combinations constitute various alternative aspects of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

A game controller of an example gaming system is arranged to select a plurality of symbols from a set of symbols and to control a display to display a plurality of the selected symbols in rows and columns. A player interface enables a player to select game features, including selecting one or more or all of the reels against which to bet credit. Each time a feature is selected, a sound generator generates a distinctive sound associated with selection of that feature. A “special” game feature may also be selected. In an embodiment, the special game feature is selection of all the reels against which to bet credit. When the special feature is deselected, by a player selecting another game feature, an alert sound is generated to alert the player to the fact that they have deselected the special game feature.

1. A gaming system, comprising a game controller arranged to control play of a game, a player interface operable by a player to affect a plurality of game features, and a sound generator arranged to generate a plurality of distinct sounds, each distinct sound being associated with operation of a respective one of the plurality of game features, the sound generator being arranged to generate an alert sound when operation of one of the game features also affects operation of another game feature.

2. A gaming system in accordance with claim 1, wherein the operation of the game feature is one or more of enabling and disabling of a game feature.

3. A gaming system in accordance with claim 2, wherein the sound generator is arranged to generate the alert sound when the another game feature is disabled in response to enabling of a game feature.

4. A gaming system in accordance with claim 1, wherein the another game feature is a special game feature.

5. A gaming system in accordance with claim 1, the player interface comprising a plurality of controls, each control being arranged to affect operation of a respective one of the plurality of game features, each one of the plurality of distinct sounds being associated with the operation of each respective control, and wherein the sound generator is arranged to generate the alert sound when operation of one of the controls also affects operation of another game feature not associated with the control.

6. A gaming system in accordance with claim 1, the game controller being arranged to control the player interface to provide a visual indication when a game feature is affected.

7. A gaming system in accordance with claim 6, wherein the visual indication is provided by illumination of the display.

8. A gaming system in accordance with claim 1, wherein the player interface comprises a display, the game controller is arranged to select a plurality of symbols from a set of symbols for play of the game, and to control the display to display a plurality of the selected symbols in one or both of rows and columns, wherein the game features controlled by the game interface are a selection of one or more of the rows or columns where the symbols are to appear, wherein the another game feature is selection of all of the rows and columns.

9. A gaming system in accordance with claim 10, arranged to implement a Reel Power™ type game, and wherein the another game feature is selection of all of the reels in the Reel Power™ display.

10. A method of gaming, comprising the steps of operating a game having a plurality of game features, generating distinct sounds, each distinct sound being associated with operation of a respective one of the plurality of game features, and generating an alert sound when operation of one of the game features also affects operation of another game feature.

11. A method in accordance with claim 10, wherein the operation of the game feature is one or more or enabling and disabling of a game feature.

12. A method in accordance with claim 11, wherein the alert sound is generated when the another game feature is disabled in response to enabling of a game feature.

13. A method in accordance with claim 10, wherein the another game feature is a special game feature.

14. A method in accordance with claim 10, comprising the further step of providing a visual indication when a game feature is affected.

15. A method in accordance with claim 14, wherein the visual indication is provided by illumination of a display.

16. A method in accordance with claim 10, wherein the step of operating the game comprises the steps of selecting a plurality of symbols from a set of symbols for play of the game, and displaying the plurality of the selected symbols in one or both of rows and columns, and operation of the game features comprises selection of one or more of the rows or columns where the symbols are to appear, wherein the another game feature is selection of all of the rows and columns.

17. A method in accordance with claim 10, wherein the game is a Reel Power™ game, and wherein the another game feature is selection of all of the reels in the Reel Power display.

18. An article of manufacture comprising:
a computer readable storage medium; and
executable program instructions embodied in the computer readable storage medium that when executed by a programmable system cause the system to perform functions that implement a gaming system comprising a game controller arranged to control play of a game, a player interface operable by a player to affect a plurality of game features, and a sound generator arranged to generate a plurality of distinct sounds, each distinct sound being associated with operation of a respective one of the plurality of game features, the sound generator being arranged to generate an alert sound when operation of one of the game features also affects operation of another game feature.
